(19) United States
(12) Patent Application Publication
(10) Pub. No.: US 2015/0070274 A1
(43) Pub. Date: Mar. 12, 2015

(54) METHODS AND SYSTEMS FOR DETERMINING 6DOF LOCATION AND ORIENTATION OF HEAD-MOUNTED DISPLAY AND ASSOCIATED USER MOVEMENTS

(71) Applicant: 3DiVi Company, Miass (RU)

(72) Inventor: Dmitry Morozov, Miass (RU)

(21) Appl. No.: 14/536,999

(22) Filed: Nov. 10, 2014

Related U.S. Application Data
(63) Continuation-in-part of application No. PCT/RU2013/000495, filed on Jun. 17, 2013.

(51) Int. Cl. G02B 27/01; G06F 3/00

(52) U.S. Cl. CPC G02B 27/017; G06F 3/005
USPC 345/156

(57) ABSTRACT

The technology described herein allows for a wearable display device, such as a head-mounted display, to be tracked within a 3D space by dynamically generating 6DoF data associated with an orientation and location of the display device within the 3D space. The 6DoF data is generated dynamically, in real time, by combining of 3DoF location information and 3DoF orientation information within a user-centered coordinate system. The 3DoF location information may be retrieved from depth maps acquired from a depth sensitive device, while the 3DoF orientation information may be received from the display device equipped with orientation and motion sensors. The dynamically generated 6DoF data can be used to provide 360-degree virtual reality simulation, which may be rendered and displayed on the wearable display device.

### CROSS-REFERENCE TO RELATED APPLICATIONS

This application is Continuation-in-Part of PCT Application No. PCT/RU2013/000495, entitled “METHODS AND SYSTEMS FOR DETERMINING 6DOF LOCATION AND ORIENTATION OF HEAD-MOUNTED DISPLAY AND ASSOCIATED USER MOVEMENTS,” filed on Jun. 17, 2013, which is incorporated herein by reference in its entirety for all purposes.

### TECHNICAL FIELD

This disclosure relates generally to human-computer interfaces and, more particularly, to the technology for dynamic determining of location and orientation data of a head-mounted display worn by a user within a three-dimensional (3D) space. The location and orientation data constitute “six-degrees of freedom” (6DoF) data which may be used in simulation of a virtual reality or in related applications.

### DESCRIPTION OF RELATED ART

The approaches described in this section could be pursued, but are not necessarily approaches that have previously been conceived or pursued. Therefore, unless otherwise indicated, it should not be assumed that any of the approaches described in this section qualify as prior art merely by virtue of their inclusion in this section.

One of the rapidly growing technologies in the field of human-computer interaction is various head-mounted or head-coupled displays, which can be worn on a user head and which have one or two small displays in front of the one or each user eye. This type of displays has multiple civilian and commercial applications involving simulation of virtual reality including video games, medicine, sport training, entertainment applications, and so forth. In the gaming field, these displays can be used, for example, to render 3D virtual game words. The important aspect of these displays is that the user is able to change a field of view by turning his head, rather than utilizing a traditional input device such as a keyboard or a trackball.

Today, the head-mounted displays or related devices include orientation sensors having a combination of gyros, accelerometers, and magnetometers, which allows for absolute (i.e., relative to earth) user head orientation tracking. In particular, the orientation sensors generate “three-degrees of freedom” (3DoF) data representing an instant orientation or rotation of the display within a 3D space. The 3DoF data provides rotational information including tilting of the display forward/backward (pitching), turning left/right (yawing), and tilting side to side (rolling).

Accordingly, by tracking the head orientation, a field of view, i.e. the extent of visible virtual 3D world seen by the user, is respectively moved in accordance with the orientation of the user head. This feature provides ultimately realistic and immersive experience for the user especially in 3D video gaming or simulation.

However, in traditional systems involving head-mounted displays, the user is required to use an input device, such as a gamepad or joystick, to control a gameplay and move within the virtual 3D world. The users of such systems may find it annoying to use input devices to make any actions in the virtual 3D world, and would rather want to use gestures or motions to generate commands for simulation in the virtual 3D world. In general, it is desired that any user motion in a real world is translated into corresponding motion in the virtual word. In other words, a user could walk in real word, while his avatar would also walk, but in the virtual world. When the user makes a hand gesture, his avatar makes the same gesture in the virtual word. When the user turns his head, the avatar makes the same motion and the field of view changes accordingly. When the user makes a step, the avatar makes the same step. Unfortunately, this functionality is not available in any commercially available platform, since traditional head-mounted displays cannot determine their absolute location within the scene and are able to track their absolute orientation only. Accordingly, today, the user experience of using the head-mounted displays for simulation of virtual reality is very limited. In addition to above, generation of a virtual avatar of the user would not be accurate or would not be even possible at all with existing technologies. Traditional head-mounted displays are not also able to determine a height of the user and thus the virtual 3D world simulation render, especially a virtual floor, may be also inaccurate.

In view of the foregoing drawbacks, there is still a need for improvements in human-computer interaction involving the use of head-mounted displays or related devices.

### SUMMARY

This summary is provided to introduce a selection of concepts in a simplified form that are further described in the Detailed Description below. This summary is not intended to identify key or essential features of the claimed subject matter, nor is it intended to be used as an aid in determining the scope of the claimed subject matter.

The present disclosure refers to methods and systems allowing for accurate and dynamic determining “six degrees of freedom” (6DoF) positional and orientation data related to an electronic device worn by a user such as a head-mounted display, head-coupled display, or head-wearable computer, all of which referred herein to as “display device” for simplicity. The 6DoF data can be used for virtual reality simulation providing better gaming and immerse experience for the user. The 6DoF data can be used in combination with a motion sensing input device providing thereby 360-degree full-body virtual reality simulation, which may allow, for example, translating user motions and gestures into corresponding motions of a user's avatar in the simulated virtual reality world.

According to various embodiments of the present disclosure, provided is a system for dynamic generating 6DoF data including a location and orientation of a display device worn by a user within a 3D environment or scene. The system may include a depth sensing device configured to obtain depth maps, a communication unit configured to receive data from the display device, and a control system configured to process the depth maps and data received from the display device so as to generate the 6DoF data facilitating simulation of a virtual reality and its components. The display device may include various motion and orientation sensors including, for example a gyro, an accelerometer, a magnetometer, or any combination thereof. These sensors may determine an absolute 3DoF (three degrees of freedom) orientation of the display device within the 3D environment. In particular, the 3DoF orientation data may represent pitch, yaw and roll data related to a rotation of the display device within a user-centered coordinate system. However, the display device may not be able to determine its absolute position within the same or any other coordinate system.

In operation, according to one or more embodiments of the present disclosure, prior to many other operations, the computing unit may dynamically receive and process depth maps generated by the depth sensing device. By processing of the depth maps, the computing unit may identify a user in the 3D scene or a plurality of users, generate a virtual skeleton of the user, and optionally identify the display device. In certain circumstances, for example, when a resolution of the depth sensing device is low, the display device or even the user head orientation may not be identified on the depth maps. In this case, the user may need, optionally and not necessarily, to perform certain actions to assist the control system to determine a location and orientation of the display device. For example, the user may be required to make a user input or make a predetermined gesture or motion informing the computing unit of that there is a display device attached or worn by the user. In certain embodiments, when a predetermined gesture is made, the depth maps may provide corresponding first motion data related to the gesture, while the display device may provide corresponding second motion data related to the same gesture. By comparing the first and second motion data, the computing unit may identify that the display device is worn by the user and thus known location of user head may be assigned to the display device. In other words, it may be established that the location of the display device is the same as the location of the user head. For these ends, coordinates of those virtual skeleton joints that relate to the user head may be assigned to the display device. Thus, the location of the display device may be dynamically tracked within the 3D environment by mere processing of the depth maps, and corresponding 3DoF location data of the display device may be generated. In particular, the 3DoF location data may include heave, sway and surge data related to a move of the display device within the 3D environment.

Further, the computing unit may dynamically (i.e., in real time) combine the 3DoF orientation data and the 3DoF location data to generate 6DoF data representing location and orientation of the display device within the 3D environment. The 6DoF may be then used in simulation of virtual reality and rendering corresponding field of view images/video that can be displayed on the display device worn or attached to the user. In certain embodiments, the virtual skeleton may be also utilized to generate a virtual avatar of the user, which may then be integrated into the virtual reality simulation so that the user may observe his avatar. Further, movements and motions of the user may be effectively translated to corresponding movements and motions of the avatar.

In one example embodiment, the 3DoF orientation data and the 3DoF location data may relate to two different coordinate systems. In another example embodiment, both the 3DoF orientation data and the 3DoF location data may relate to one and the same coordinate system. In the latter case, the computing unit may establish and fix the user-centered coordinate system prior to many operations discussed herein. For example, the computing unit may set an origin of the user-centered coordinate system in the location of initial position of the user head based on the processing of the depth maps. The direction of the axes of this coordinate system may be set based on a line of vision of the user or user head orientation, which may be determined by a number of different approaches.

In one example, by processing the depth maps, the computing unit may determine an orientation of the user head, which may be used for assuming the line of vision of the user. One of the coordinate system axes may be then bound to the line of vision of the user. In another example, the virtual skeleton may be generated based on the depth maps, which may have virtual joints. A relative position of two or more virtual skeleton joints (e.g., pertained to user shoulders) may be used for selecting directions of the coordinate system axes. In yet another example, the user may be prompted to make a gesture such as a motion of his hand in the direction from his head towards the depth sensing device. The motion of the user may generate motion data, which in turn may serve a basis for selection directions of the coordinate system axes. In yet another example, there may be provided an optional video camera, which may generate a video stream. By processing of the video stream, the computing unit may identify various elements of the user head such as pupils, nose, ears, etc. Based on position of these elements, the computing unit may determine the line of vision and then set directions of the coordinate system axes based thereupon. Accordingly, once the user-centered coordinate system is set, all other motions of the display device may be tracked within this coordinate system making it easy to utilize 6DoF data generated later on.

According to one or more embodiments of the present disclosure, the user may stand on a floor or on an omnidirectional treadmill. When the user stands on a floor of premises, he may naturally move on the floor within certain limits so as the computing unit may generate corresponding 6DoF data related to location and orientation of the display device worn by the user in real time as it is discussed above.

However, when the omnidirectional treadmill is utilized, the user substantially remains in one and the same location. In this case, similarly to above described approaches, 6DoF data may be based on a combination of 3DoF orientation data acquired from the display device and 3DoF location data, which may be obtained by processing the depth maps and/or acquiring data from the omnidirectional treadmill. In one example, the depth maps may be processed to retrieve heave data (i.e., 1DoF location data related to movements of the user head up or down), while sway and surge data (i.e., 2DoF location data related to movements of the user in a horizontal plane) may be received from the omnidirectional treadmill. In another example, the 3DoF location data may be generated by merely processing of the depth maps. In this case, the depth maps may be processed so as to create a virtual skeleton of the user including multiple virtual joints associated with user legs and at least one virtual joint associated with the user head. Accordingly, when the user walks/runs on the omnidirectional treadmill, the virtual joints associated with user legs may be dynamically tracked and analysed by processing of the depth maps so as sway and surge data (2DoF location data) can be generated. Similarly, the virtual joint(s) associated with the user head may be dynamically tracked and analysed by processing of the depth maps so as heave data (1DoF location data) may be generated. Thus, the computing unit may combine heave, sway, and surge data to generate 3DoF location data. As discussed above, the 3DoF location data may be combined with the 3DoF orientation data acquired from the display device to create 6DoF data.

Thus, the present technology allows for 6DoF based virtual reality simulation, which technology does not require immoderate computational resources or high resolution depth sensing devices. This technology provides multiple benefits for the user including improved and more accurate virtual reality simulation as well as better gaming experience, which includes such new options as viewing user's avatar on the display device or ability to walk around virtual objects, and so forth. Other features, aspects, examples, and embodiments are described below.

### BRIEF DESCRIPTION OF THE DRAWINGS

Embodiments are illustrated by way of example, and not by limitation in the figures of the accompanying drawings, in which like references indicate similar elements and in which:

FIG. 1A shows an example scene suitable for implementation of a real time human-computer interface employing various aspects of the present technology.

FIG. 1B shows another example scene which includes the use of an omnidirectional treadmill according to various aspects of the present technology.

FIG. 2 shows an exemplary user-centered coordinate system suitable for tracking user motions within a scene.

FIG. 3 shows a simplified view of an exemplary virtual skeleton as can be generated by a control system based upon the depth maps.

FIG. 4 shows a simplified view of exemplary virtual skeleton associated with a user wearing a display device.

FIG. 5 shows a high-level block diagram of an environment suitable for implementing methods for determining a location and an orientation of a display device such as a head-mounted display.

FIG. 6 shows a high-level block diagram of a display device, such as a head-mounted display, according to an example embodiment.

FIG. 7 is a process flow diagram showing an example method for determining a position and orientation of a display device within a 3D environment.

FIG. 8 is a diagrammatic representation of an example machine in the form of a computer system within which a set of instructions for the machine to perform any one or more of the methodologies discussed herein is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein may be implemented using a variety of technologies. For example, the methods described herein may be implemented in software executing on a computer system or in hardware utilizing either a combination of microprocessors, controllers or other specially designed application-specific integrated circuits (ASICs), programmable logic devices, or various combinations thereof. In particular, the methods described herein may be implemented by a series of computer-executable instructions residing on a storage medium such as a disk drive, solid-state drive or on a computer-readable medium.

### INTRODUCTION & TERMINOLOGY

The embodiments described herein relate to computer-implemented methods and corresponding systems for determining and tracking 6DoF location and orientation data of a display device within a 3D space, which data may be used for enhanced virtual reality simulation.

The term “display device,” as used herein, may refer to one or more of the following: a head-mounted display, a head-coupled display, a helmet-mounted display, and a wearable computer having a display (e.g., a head-mounted computer with a display). The display device, worn on a head of a user or as part of a helmet, has a small display optic in front of one (monocular display device) or each eye (binocular display device). The display device has either one or two small displays with lenses and semi-transparent mirrors embedded in a helmet, eye-glasses (also known as data glasses) or visor. The display units may be miniaturized and may include a Liquid Crystal Display (LCD), Organic Light-Emitting Diode (OLED) display, or the like. Some vendors may employ multiple micro-displays to increase total resolution and field of view.

The display devices incorporate one or more head-tracking devices that can report the orientation of the user head so that the displayable field of view can be updated appropriately. The head tracking devices may include one or more motion and orientation sensors such as a gyro, an accelerometer, a magnetometer, or a combination thereof. Therefore, the display device may dynamically generate 3DoF orientation data of the user head, which data may be associated with a user-centered coordinate system. In some embodiments, the display device may also have a communication unit, such as a wireless or wired transmitter, to send out the 3DoF orientation data of the user head to a computing device for further processing.

The term “3DoF orientation data,” as used herein, may refer to three-degrees of freedom orientation data including information associated with tilting the user head forward or backward (pitching data), turning the user head left or right (yawing data), and tilting the user head side to side (rolling data).

The terms “3DoF location data” or “3DoF positional data,” as used herein, may refer to three-degrees of freedom location data including information associated with moving the user head up or down (heaving data), moving the user head left or right (swaying data), and moving the user head forward or backward (surging data).

The term “6DoF data,” as used herein, may refer to a combination of 3DoF orientation data and 3DoF location data associated with a common coordinate system, e.g. the user-centered coordinate system, or, in more rare cases, two different coordinate systems.

The term “coordinate system,” as used herein, may refer to 3D coordinate system, for example, a 3D Cartesian coordinate system. The term “user-centered coordinate system” is related to a coordinate system associated with a user head and/or the display device (i.e., its motion and orientation sensors).

The term “depth sensitive device,” as used herein, may refer to any suitable electronic device capable to generate depth maps of a 3D space. Some examples of the depth sensitive device include a depth sensitive camera, 3D camera, depth sensor, video camera configured to process images to generate depth maps, and so forth. The depth maps can be processed by a control system to locate a user present within a 3D space and also its body parts including a user head, limbs. In certain embodiments, the control system may identify the display device worn by a user. Further, the depth maps, when processed, may be used to generate a virtual skeleton of the user.

The term “virtual reality” may refer to a computer-simulated environment that can simulate physical presence in places in the real world, as well as in imaginary worlds. Most current virtual reality environments are primarily visual experiences, but some simulations may include additional sensory information, such as sound through speakers or headphones. Some advanced, haptic systems may also include tactile information, generally known as force feedback, in medical and gaming applications.

The term “avatar,” as used herein, may refer to a visible representation of a user's body in a virtual reality world. An avatar can resemble the user's physical body, or be entirely different, but typically it corresponds to the user's position, movement and gestures, allowing the user to see their own virtual body, as well as for other users to see and interact with them.

The term “field of view,” as used herein, may refer to the extent of a visible world seen by a user or a virtual camera. For a head-mounted display, the virtual camera's visual field should be matched to the visual field of the display.

The term “control system,” as used herein, may refer to any suitable computing apparatus or system configured to process data, such as 3DoF and 6DoF data, depth maps, user inputs, and so forth. Some examples of control system may include a desktop computer, laptop computer, tablet computer, gaming console, audio system, video system, cellular phone, smart phone, personal digital assistant, set-top box, television set, smart television system, in-vehicle computer, infotainment system, and so forth. In certain embodiments, the control system may be incorporated or operatively coupled to a game console, infotainment system, television device, and so forth. In certain embodiments, at least some elements of the control system may be incorporated into the display device (e.g., in a form of head-wearable computer).

The control system may be in a wireless or wired communication with a depth sensitive device and a display device (i.e., a head-mounted display). In certain embodiments, the term “control system” may be simplified to or be interchangeably mentioned as “computing device,” “processing means” or merely a “processor”.

According to embodiments of the present disclosure, a display device can be worn by a user within a particular 3D space such as a living room of premises. The user may be present in front of a depth sensing device which generates depth maps. The control system processes depth maps received from the depth sensing device and, by the result of the processing, the control system may identify the user, user head, user limbs, generates a corresponding virtual skeleton of the user, and tracks coordinates of the virtual skeleton within the 3D space. The control system may also identify that the user wears or other way utilizes the display device and then may establish a user-centered coordinate system. The origin of the user-centered coordinate system may be set to initial coordinates of those virtual skeleton joints that relate to the user head. The direction of axes may be bound to initial line of vision of the user. The line of vision may be determined by a number of different ways, which may include, for example, determining the user head orientation, coordinates of specific virtual skeleton joints, identifying pupils, nose, and other user head parts. In some other examples, the user may need to make a predetermined gesture (e.g., a nod or hand motion) so as to assist the control system to identify the user and his head orientation. Accordingly, the user-centered coordinate system may be established at initial steps and it may be fixed so that all successive movements of the user are tracked on the fixed user-centered coordinate system. The movements may be tracked so that 3DoF location data of the user head is generated.

Further, the display device dynamically receives 3DoF orientation data from the display device. It should be noted that the 3DoF orientation data may be, but not necessarily, associated with the same user-centered coordinate system. Further, the control system may combine the 3DoF orientation data and 3DoF location data to generate 6DoF data. The 6DoF data can be further used in virtual reality simulation, generating a virtual avatar, translating the user's movements and gestures in the real world into corresponding movements and gestures of the user's avatar in the virtual world, generating an appropriate field of view based on current user head orientation and location, and so forth.

Below are provided a detailed description of various embodiments and of examples with reference to the drawings.

Human-Computer Interface and Coordinate System

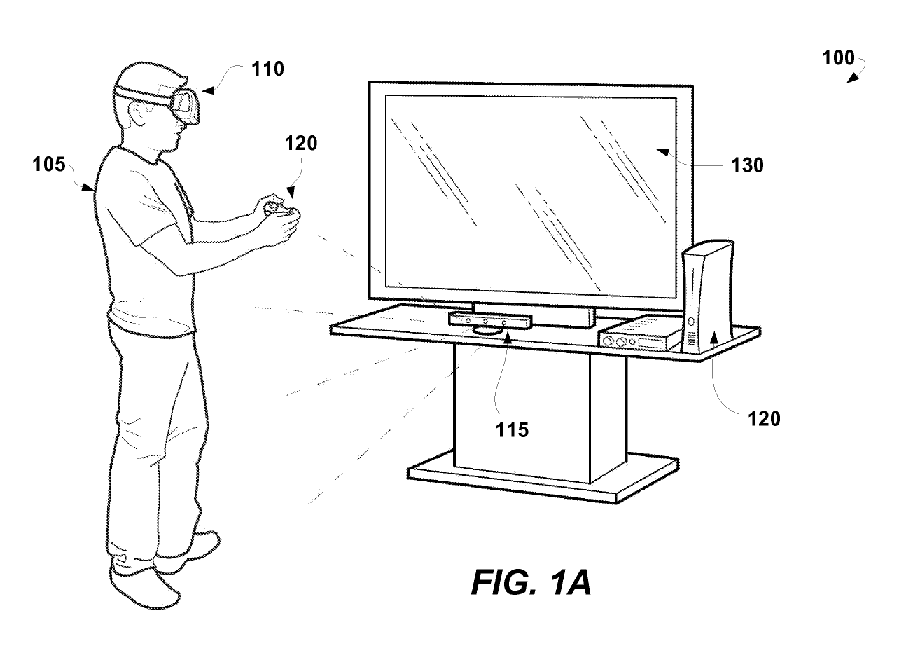

With reference now to the drawings, FIG. 1A shows an example scene 100 suitable for implementation of a real time human-computer interface employing the present technology. In particular, there is shown a user 105 wearing a display device 110 such as a head-mounted display. The user 105 is present in a space being in front of a control system 115 which includes a depth sensing device so that the user 105 can be present in depth maps generated by the depth sensing device. In certain embodiments, the control system 115 may also (optionally) include a digital video camera to assist in tracking the user 105, identify his motions, emotions, etc. The user 105 may stand on a floor (not shown) or on an omnidirectional treadmill (not shown).

The control system 115 may also receive 3DoF orientation data from the display device 110 as generated by internal orientation sensors (not shown). The control system 115 may be in communication with an entertainment system or a game console 120. In certain embodiments, the control system 115 and a game console 120 may constitute a single device.

The user 105 may optionally hold or use one or more input devices to generate commands for the control system 115. As shown in the figure, the user 105 may hold a handheld device 125, such as a gamepad, smart phone, remote control, etc., to generate specific commands, for example, shooting or moving commands in case the user 105 plays a video game. The handheld device 125 may also wirelessly transmit data and user inputs to the control system 115 for further processing. In certain embodiments, the control system 115 may also be configured to receive and process voice commands of the user 105.

In certain embodiments, the handheld device 125 may also include one or more sensors (gyros, accelerometers and/or magnetometers) generating 3DoF orientation data. The 3DoF orientation data may be transmitted to the control system 115 for further processing. In certain embodiments, the control system 115 may determine the location and orientation of the handheld device 125 within a user-centered coordinate system or any other secondary coordinate system.

The control system 115 may also simulate a virtual reality and generate a virtual world. Based on the location and/or orientation of the user head, the control system 115 renders a corresponding graphical representation of field of view and transmits it to the display device 110 for presenting to the user 105. In other words, the display device 110 displays the virtual word to the user. According to multiple embodiments of the present disclosure, the movement and gestures of the user or his body parts are tracked by the control system 115 such that any user movement or gesture is translated into a corresponding movement of the user 105 within the virtual world. For example, if the user 105 wants to go around a virtual object, the user 105 may need to make a circle movement in the real world.

This technology may also be used to generate a virtual avatar of the user 105 based on the depth maps and orientation data received from the display device 110. The avatar can be also presented to the user 105 via the display device 110. Accordingly, the user 105 may play third-party games, such as third party shooters, and see his avatar making translated movements and gestures from the sidelines.

Another important aspect is that the control system 115 may accurately determine a user height or a distance between the display device 110 and a floor (or an omnidirectional treadmill) within the space where the user 105 is present. The information allows for more accurate simulation of a virtual floor. One should understand that the present technology may be also used for other applications or features of virtual reality simulation.

Still referring to FIG. 1A, the control system 115 may also be operatively coupled to peripheral devices. For example, the control system 115 may communicate with a display 130 or a television device (not shown), audio system (not shown), speakers (not shown), and so forth. In certain embodiments, the display 130 may show the same field of view as presented to the user 105 via the display device 110.

For those skilled in the art it should be clear that the scene 100 may include more than one user 105. Accordingly, if there are several users 105, the control system 115 may identify each user separately and track their movements and gestures independently.

FIG. 1B shows another exemplary scene 150 suitable for implementation of a real time human-computer interface employing the present technology. In general, this scene 150 is similar to the scene 100 shown in FIG. 1A, but the user 105 stands not on a floor, but on an omnidirectional treadmill 160.

The omnidirectional treadmill 160 is a device that may allow the user 105 to perform locomotive motions in any directions. Generally speaking, the ability to move in any direction is what makes the omnidirectional treadmill 160 different from traditional one-direction treadmills. In certain embodiments, the omnidirectional treadmill 160 may also generate information of user movements, which may include, for example, a direction of user movement, a user speed/pace, a user acceleration/deceleration, a width of user step, user step pressure, and so forth. For these ends, the omnidirectional treadmill 160 may employ one or more sensors (not shown) enabling to generate such 2DoF (two degrees of freedom) location data including sway and surge data of the user (i.e., data related to user motions within a horizontal plane). The sway and surge data may be transmitted from the omnidirectional treadmill 160 to the control system 115 for further processing.

Heave data (i.e., 1DoF location data) associated with the user motions up and down may be created by processing of the depth maps generated by the depth sensing device. Alternatively, the user height (i.e., in between the omnidirectional treadmill 160 and the user head) may be dynamically determined by the control system 115. The combination of said sway, surge and heave data may constitute 3DoF location data, which may be then used by the control system 115 for virtual reality simulation as described herein.

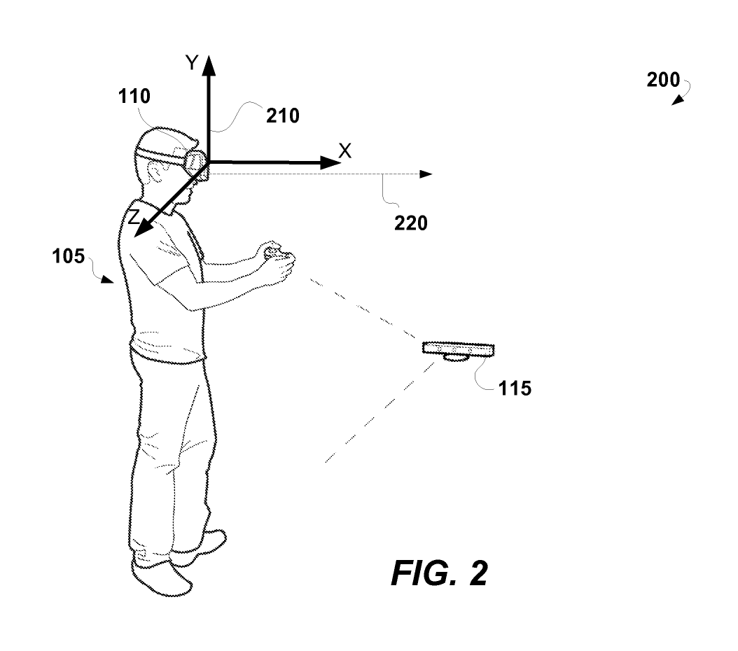

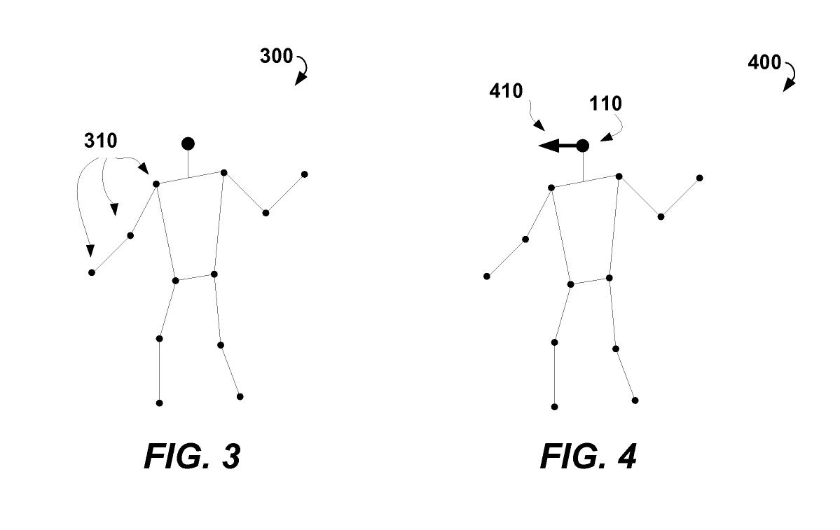

In another example embodiment, the omnidirectional treadmill 160 may not have any embedded sensors to detect user movements. In this case, 3DoF location data of the user may be still generated by solely processing the depth maps. Specifically, as will be explained below in more details, the depth maps may be processed to create a virtual skeleton of the user 105. The virtual skeleton may have a plurality of moveable virtual bones and joints therebetween (see FIGS. 3 and 4). Provided the depth maps are generated continuously, user motions may be translated into corresponding motions of the virtual skeleton bones and/or joints. The control system 115 may then track motions of those virtual skeleton bones and/or joints, which relate to user legs. Accordingly, the control system 115 may determine every user step, its direction, pace, width, and other parameters. In this regard, by tracking motions of the user legs, the control system 115 may create 2DoF location data associated with user motions within a horizontal plane, or in other words, sway and surge data are created.

Similarly, one or more virtual joints associated with the user head may be tracked in real time to determine the user height and whether the user head goes up or down (e.g., to identify if the user jumps and if so, what is a height and pace of the jump). Thus, 1DoF location data or heave data are generated. The control system 115 may then combine said sway, surge and heave data to generate 3DoF location data.

Thus, the control system 115 may dynamically determine the user's location data if he utilizes the omnidirectional treadmill 160. Regardless of what motions or movements the user 105 makes, the depth maps and/or data generated by the omnidirectional treadmill 160 may be sufficient to identify where the user 105 moves, how fast, what is motion acceleration, whether he jumps or not, and if so, at what height and how his head is moving. In some examples, the user 105 may simply stand on the omnidirectional treadmill 160, but his head may move with respect to his body. In this case, the location of user head may be accurately determined as discussed herein. In some other examples, the user head may move and the user may also move on the omnidirectional treadmill 160. Similarly, both motions of the user head and user legs may be tracked. In yet more example embodiments, the movements of the user head and all user limbs may be tracked so as to provide a full body user simulation where any motion in the real world may be translated into corresponding motions in the virtual world.

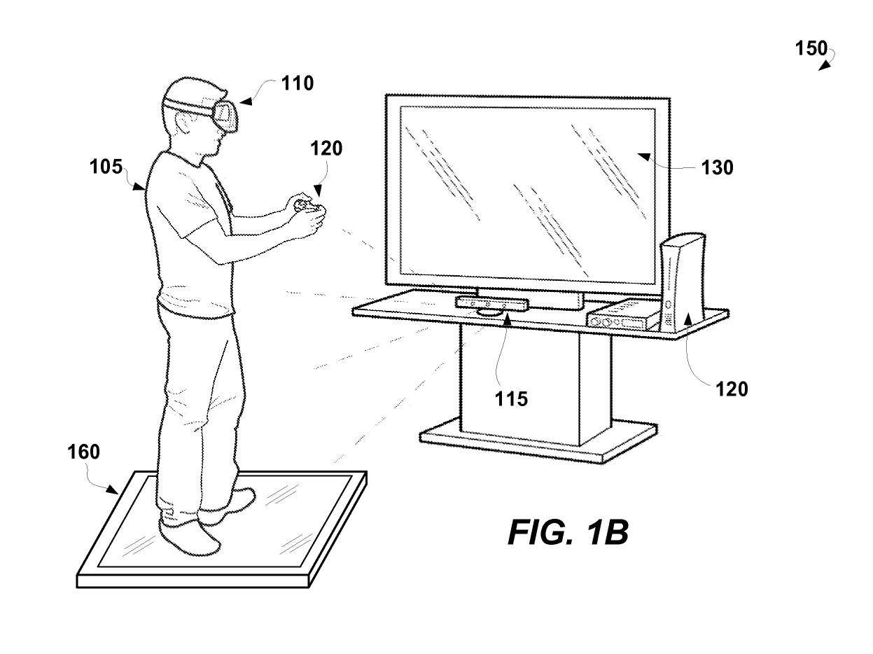

FIG. 2 shows an exemplary user-centered coordinate system 210 suitable for tracking user motions within the same scene 100. The user-centered coordinate system 210 may be created by the control system 115 at initial steps of operation (e.g., prior virtual reality simulation). In particular, once the user 105 appeared in from of the depth sensing device and wants to initiate simulation of virtual reality, the control system 115 may process the depth maps and identify the user, the user head, and user limbs. The control system 115 may also generate a virtual skeleton (see FIGS. 3 and 4) of the user and track motions of its joints. Provided the depth sensing device has low resolution, it may not reliably identify the display device 110 worn by the user 105. In this case, the user may need to make an input (e.g., a voice command) to inform the control system 115 that the user 105 has the display device 110. Alternatively, the user 105 may need to make a gesture (e.g., a nod motion or any other motion of the user head). In this case, the depth maps may be processed to retrieve first motion data associated with the gesture, while second motion data related to the same gesture may be acquired from the display device 110 itself. By comparing the first and second motion data, the control system 115 may unambiguously identify that the user 105 wears the display device 110 and then the display device 110 may be assigned with coordinates of those virtual skeleton joints that relate to the user head. Thus, the initial location of the display device 110 may be determined.

Further, the control system 115 may be required to identify an orientation of the display device 110. This may be performed by a number of different ways.

In an example, the orientation of the display device 110 may be bound to the orientation of the user head or the line of vision of the user 105. Any of these two may be determined by analysis of coordinates related to specific virtual skeleton joints (e.g., user head, shoulders). Alternatively, the line of vision or user head orientation may be determined by processing images of the user taken by a video camera, which processing may involve locating pupils, nose, ears, etc. In yet another example, as discussed above, the user may need to make a predetermined gesture such a nod motion or user hand motion. By tracking motion data associated with such predetermined gestures, the control system 110 may identify the user head orientation. In yet another example embodiment, the user may merely provide a corresponding input (e.g., a voice command) to identify an orientation of the display device 110.

Thus, the orientation and location of the display device 110 may became known to the control system 115 prior to the virtual reality simulation. The user-centered coordinate system 210, such as 3D Cartesian coordinate system, may be then bound to these initial orientation and location of the display device 110. For example, the origin of the user-centered coordinate system 210 may be set to the instant location of the display device 110. Direction of axes of the user-centered coordinate system 210 may be bound to the user head orientation or the line of vision. For example, the axis X of the user-centered coordinate system 210 may coincide with the line of vision 220 of the user. Further, the user-centered coordinate system 210 is fixed and all successive motions and movements of the user 105 and the display device 110 are tracked with respect to this fixed user-centered coordinate system 210.

It should be noted that in certain embodiments, an internal coordinate system used by the display device 110 may be bound or coincide with the user-centered coordinate system 210. In this regard, the location and orientation of the display device 110 may be further tracked in one and the same coordinate system.

Virtual Skeleton Representation

FIG. 3 shows a simplified view of an exemplary virtual skeleton 300 as can be generated by the control system 115 based upon the depth maps. As shown in the figure, the virtual skeleton 300 comprises a plurality of virtual “joints” 310 interconnecting virtual “bones”. The bones and joints, in combination, may represent the user 105 in real time so that every motion, movement or gesture of the user can be represented by corresponding motions, movements or gestures of the bones and joints.

According to various embodiments, each of the joints 310 may be associated with certain coordinates in a coordinate system defining its exact location within the 3D space. Hence, any motion of the user's limbs, such as an arm or head, may be interpreted by a plurality of coordinates or coordinate vectors related to the corresponding joint(s) 310. By tracking user motions utilizing the virtual skeleton model, motion data can be generated for every limb movement. This motion data may include exact coordinates per period of time, velocity, direction, acceleration, and so forth.

FIG. 4 shows a simplified view of exemplary virtual skeleton 400 associated with the user 105 wearing the display device 110. In particular, when the control system 115 determines that the user 105 wears display device 110 and then assign the location (coordinates) of the display device 110, a corresponding label (not shown) can be associated with the virtual skeleton 400.

According to various embodiments, the control system 115 can acquire an orientation data of the display device 110. The orientation of the display device 110, in an example, may be determined by one or more sensors of the display device 110 and then transmitted to the control system 115 for further processing. In this case, the orientation of display device 110 may be represented as a vector 410 as shown in FIG. 4. Similarly, the control system 115 may further determine a location and orientation of the handheld device(s) 125 held by the user 105 in one or two hands. The orientation of the handheld device(s) 125 may be also presented as one or more vectors (not shown).

Control System

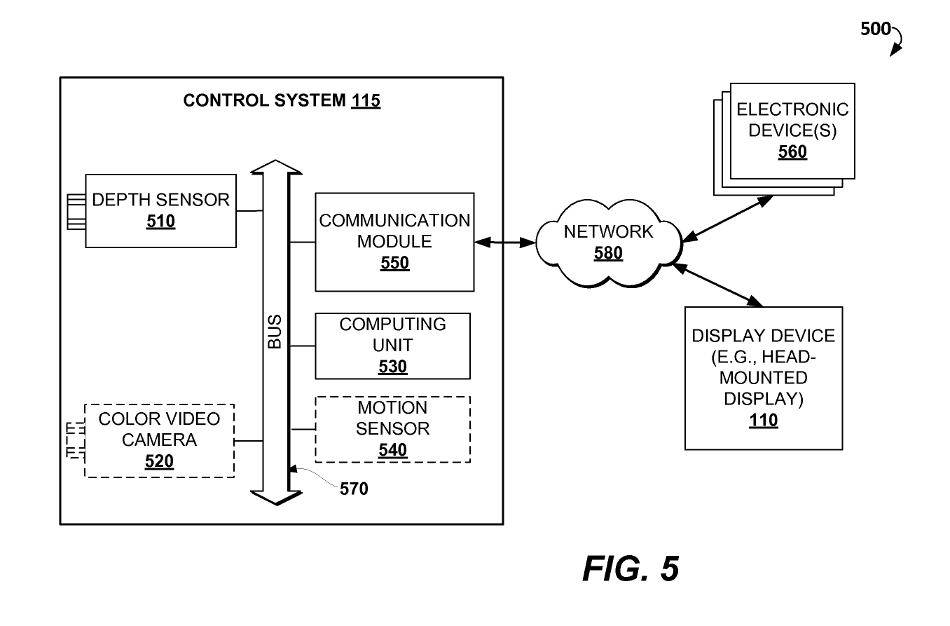

FIG. 5 shows a high-level block diagram of an environment 500 suitable for implementing methods for determining a location and an orientation of a display device 110 such as a head-mounted display. As shown in this figure, there is provided the control system 115, which may comprise at least one depth sensor 510 configured to dynamically capture depth maps. The term “depth map,” as used herein, refers to an image or image channel that contains information relating to the distance of the surfaces of scene objects from a depth sensor 510. In various embodiments, the depth sensor 510 may include an infrared (IR) projector to generate modulated light, and an IR camera to capture 3D images of reflected modulated light. Alternatively, the depth sensor 510 may include two digital stereo cameras enabling it to generate depth maps. In yet additional embodiments, the depth sensor 510 may include time-of-flight sensors or integrated digital video cameras together with depth sensors.

In some example embodiments, the control system 115 may optionally include a color video camera 520 to capture a series of two-dimensional (2D) images in addition to 3D imagery already created by the depth sensor 510. The series of 2D images captured by the color video camera 520 may be used to facilitate identification of the user, and/or various gestures of the user on the depth maps, facilitate identification of user emotions, and so forth. In yet more embodiments, the only color video camera 520 can be used, and not the depth sensor 510. It should also be noted that the depth sensor 510 and the color video camera 520 can be either stand alone devices or be encased within a single housing.

Furthermore, the control system 115 may also comprise a computing unit 530, such as a processor or a Central Processing Unit (CPU), for processing depth maps, 3DoF data, user inputs, voice commands, and determining 6DoF location and orientation data of the display device 110 and optionally location and orientation of the handheld device 125 as described herein. The computing unit 530 may also generate virtual reality, i.e. render 3D images of virtual reality simulation which images can be shown to the user 105 via the display device 110. In certain embodiments, the computing unit 530 may run game software. Further, the computing unit 530 may also generate a virtual avatar of the user 105 and present it to the user via the display device 110.

In certain embodiments, the control system 115 may optionally include at least one motion sensor 540 such as a movement detector, accelerometer, gyroscope, magnetometer or alike. The motion sensor 540 may determine whether or not the control system 115 and more specifically the depth sensor 510 is/are moved or differently oriented by the user 105 with respect to the 3D space. If it is determined that the control system 115 or its elements are moved, then mapping between coordinate systems may be needed or a new user-centered coordinate system 210 shall be established. In certain embodiments, when the depth sensor 510 and/or the color video camera 520 are separate devices not present in a single housing with other elements of the control system 115, the depth sensor 510 and/or the color video camera 520 may include internal motion sensors 540. In yet other embodiments, at least some elements of the control system 115 may be integrated with the display device 110.

The control system 115 also includes a communication module 550 configured to communicate with the display device 110, one or more optional input devices such as a handheld device 125, and one or more optional peripheral devices such as an omnidirectional treadmill 160. More specifically, the communication module 550 may be configured to receive orientation data from the display device 110, orientation data from the handheld device 125, and transmit control commands to one or more electronic devices 560 via a wired or wireless network. The control system 115 may also include a bus 570 interconnecting the depth sensor 510, color video camera 520, computing unit 530, optional motion sensor 540, and communication module 550. Those skilled in the art will understand that the control system 115 may include other modules or elements, such as a power module, user interface, housing, control key pad, memory, etc., but these modules and elements are not shown not to burden the description of the present technology.

The aforementioned electronic devices 560 can refer, in general, to any electronic device configured to trigger one or more predefined actions upon receipt of a certain control command. Some examples of electronic devices 560 include, but are not limited to, computers (e.g., laptop computers, tablet computers), displays, audio systems, video systems, gaming consoles, entertainment systems, home appliances, and so forth.

The communication between the control system 115 (i.e., via the communication module 550) and the display device 110, one or more optional input devices 125, one or more optional electronic devices 560 can be performed via a network 580. The network 580 can be a wireless or wired network, or a combination thereof. For example, the network 580 may include, for example, the Internet, local intranet, PAN (Personal Area Network), LAN (Local Area Network), WAN (Wide Area Network), MAN (Metropolitan Area Network), virtual private network (VPN), storage area network (SAN), frame relay connection, Advanced Intelligent Network (AIN) connection, synchronous optical network (SONET) connection, digital T1, T3, E1 or E3 line, Digital Data Service (DDS) connection, DSL (Digital Subscriber Line) connection, Ethernet connection, ISDN (Integrated Services Digital Network) line, cable modem, ATM (Asynchronous Transfer Mode) connection, or an FDDI (Fiber Distributed Data Interface) or CDDI (Copper Distributed Data Interface) connection. Furthermore, communications may also include links to any of a variety of wireless networks including WAP (Wireless Application Protocol), GPRS (General Packet Radio Service), GSM (Global System for Mobile Communication), CDMA (Code Division Multiple Access) or TDMA (Time Division Multiple Access), cellular phone networks, Global Positioning System (GPS), CDPD (cellular digital packet data), RIM (Research in Motion, Limited) duplex paging network, Bluetooth radio, or an IEEE 802.11-based radio frequency network.

Display Device

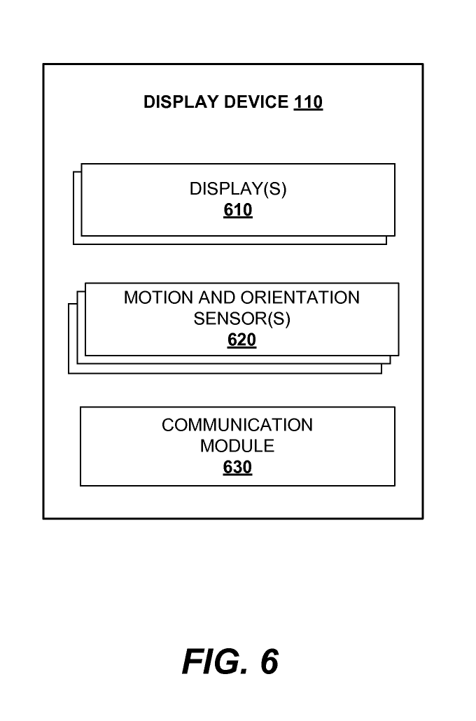

FIG. 6 shows a high-level block diagram of the display device 110, such as a head-mounted display, according to an example embodiment. As shown in the figure, the display device 110 includes one or two displays 610 to visualize the virtual reality simulation as rendered by the control system 115, a game console or related device. In certain embodiments, the display device 110 may also present a virtual avatar of the user 105 to the user 105.

The display device 110 may also include one or more motion and orientation sensors 620 configured to generate 3DoF orientation data of the display device 110 within, for example, the user-centered coordinate system.

The display device 110 may also include a communication module 630 such as a wireless or wired receiver-transmitter. The communication module 630 may be configured to transmit the 3DoF orientation data to the control system 115 in real time. In addition, the communication module 630 may also receive data from the control system 115 such as a video stream to be displayed via the one or two displays 610.

In various alternative embodiments, the display device 110 may include additional modules (not shown), such as an input module, a battery, a computing module, memory, speakers, headphones, touchscreen, and/or any other modules, depending on the type of the display device 110 involved.

The motion and orientation sensors 620 may include gyroscopes, magnetometers, accelerometers, and so forth. In general, the motion and orientation sensors 620 are configured to determine motion and orientation data which may include acceleration data and rotational data (e.g., an attitude quaternion), both associated with the first coordinate system.

Examples of Operation

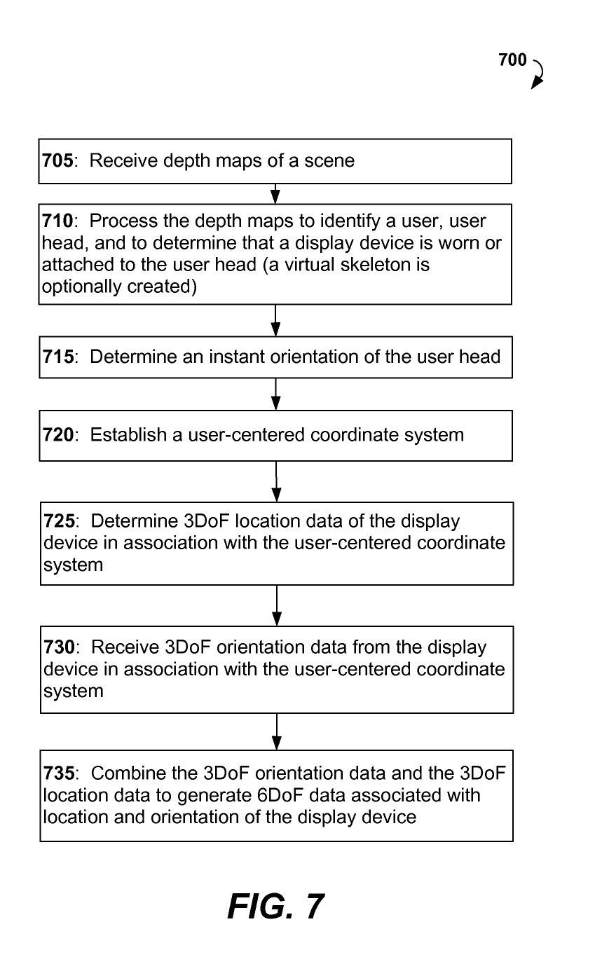

FIG. 7 is a process flow diagram showing an example method 700 for determining a location and orientation of a display device 110 within a 3D environment. The method 700 may be performed by processing logic that may comprise hardware (e.g., dedicated logic, programmable logic, and microcode), software (such as software run on a general-purpose computer system or a dedicated machine), or a combination of both. In one example embodiment, the processing logic resides at the control system 115.

The method 700 can be performed by the units/devices discussed above with reference to FIG. 5. Each of these units or devices may comprise processing logic. It will be appreciated by one of ordinary skill in the art that examples of the foregoing units/devices may be virtual, and instructions said to be executed by a unit/device may in fact be retrieved and executed by a processor. The foregoing units/devices may also include memory cards, servers, and/or computer discs. Although various modules may be configured to perform some or all of the various steps described herein, fewer or more units may be provided and still fall within the scope of example embodiments.

As shown in FIG. 7, the method 700 may commence at operation 705 with receiving, by the computing unit 530, one or more depth maps of a scene, where the user 105 is present. The depth maps may be created by the depth sensor 510 and/or video camera 520 in real time.

At operation 710, the computing unit 530 processes the one or more depth maps to identify the user 105, the user head, and to determine that the display device 110 is worn by the user 105 or attached to the user head. The computing unit 530 may also generate a virtual skeleton of the user 105 based on the depth maps and then track coordinates of virtual skeleton joints in real time.

The determining that the display device 110 is worn by the user 105 or attached to the user head may be done solely by processing of the depth maps, if the depth sensor 510 is of high resolution. Alternatively, when the depth sensor 510 is of low resolution, the user 105 should make an input or a predetermined gesture so as the control system 115 is notified that the display device 110 is on the user head and thus coordinates of the virtual skeleton related to the user head may be assigned to the display device 110. In an embodiment, when the user should make a gesture (e.g., a nod motion), the depth maps are processed so as to generate first motion data related to this gesture, and the display device 110 also generates second motion data related to the same motion by its sensors 620. The first and second motion data may then be compared by the control system 115 so as to find a correlation therebetween. If the motion data are correlated to each other in some way, the control system 115 makes a decision that the display device 110 is on the user head. Accordingly, the control system may assign coordinates of the user head to the display device 110, and by tracking location of the user head, the location of the display device 110 would be also tracked. Thus, a location of the display device 110 may become known to the control system 115 as it may coincide with the location of the user head.

At operation 715, the computing unit 530 determines an instant orientation of the user head. In one example, the orientation of the user head may be determined solely by depth maps data. In another example, the orientation of the user head may be determined by determining a line of vision 220 of the user 105, which line in turn may be identified by locating pupils, nose, ears, or other user body parts. In another example, the orientation of the user head may be determined by analysis of coordinates of one or more virtual skeleton joints associated, for example, with user shoulders.

In another example, the orientation of the user head may be determined by prompting the user 105 to make a predetermined gesture (e.g., the same motion as described above with reference to operation 710) and then identifying that the user 105 makes such a gesture. In this case, the orientation of the user head may be based on motion data retrieved from corresponding depth maps. The gesture may relate, for example, to a nod motion, a motion of user hand from the user head towards the depth sensor 105, a motion identifying the line of vision 220.

In yet another example, the orientation of the user head may be determined by prompting the user 105 to make a user input such as an input using a keypad, a handheld device 125, or a voice command. The user input may identify for the computing unit 530 the orientation of the user head or line of vision 220.

At operation 720, the computing unit 530 establishes a user-centered coordinate system 210. The origin of the user-centered coordinate system 210 may be bound to the virtual skeleton joint(s) associated with the user head. The orientation of the user-centered coordinate system 210, or in other words the direction of its axes may be based upon the user head orientation as determined at operation 715. For example, one of the axes may coincide with the line of vision 220. As discussed above, the user-centered coordinate system 210 may be established once (e.g., prior to many other operations) and it is fixed so that all successive motions or movements of the user head and thus the user display are tracked with respect to the fixed user-centered coordinate system 210. However, it should be clear that in certain applications, two different coordinate systems may be utilized to track orientation and location of the user head and also of the display device 110.

At operation 725, the computing unit 530 dynamically determines 3DoF location data of the display device 110 (or the user head). This data can be determined solely by processing the depth maps. Further, it should be noted that the 3DoF location data may include heave, sway, and surge data related to a move of the display device 110 within the user-centered coordinate system 210.

At operation 730, the computing unit 530, receives 3DoF orientation data from the display device 110. The 3DoF orientation data may represent rotational movements of the display device 110 (and accordingly the user head) including pitch, yaw, and roll data within the user-centered coordinate system 210. The 3DoF orientation data may be generated by one or more motion or orientation sensors 610.

At operation 735, the computing unit 530 combines the 3DoF orientation data and the 3DoF location data to generate 6DoF data associated with the display device 110. The 6DoF data can be further used in virtual reality simulation and rendering corresponding field of view images to be displayed on the display device 110. This 6DoF data can be also used by 3D engine of a computer game. The 6DoF data can be also utilized along with the virtual skeleton to create a virtual avatar of the user 105. The virtual avatar may be also displayed on the display device 110. In general, the 6DoF data can be utilized by the computing unit 530 only and/or this data can be sent to one or more peripheral electronic devices 560 such as a game console for further processing and simulation of a virtual reality.

Some additional operations (not shown) of the method 700 may include identifying, by the computing unit 530, coordinates of a floor of the scene based at least in part on the one or more depth maps. The computing unit 530 may further utilize these coordinates to dynamically determine a distance between the display device 110 and the floor (in other words, the user's height). This information may also be utilized in simulation of virtual reality as it may facilitate the front of view rendering.

Example of Computing Device

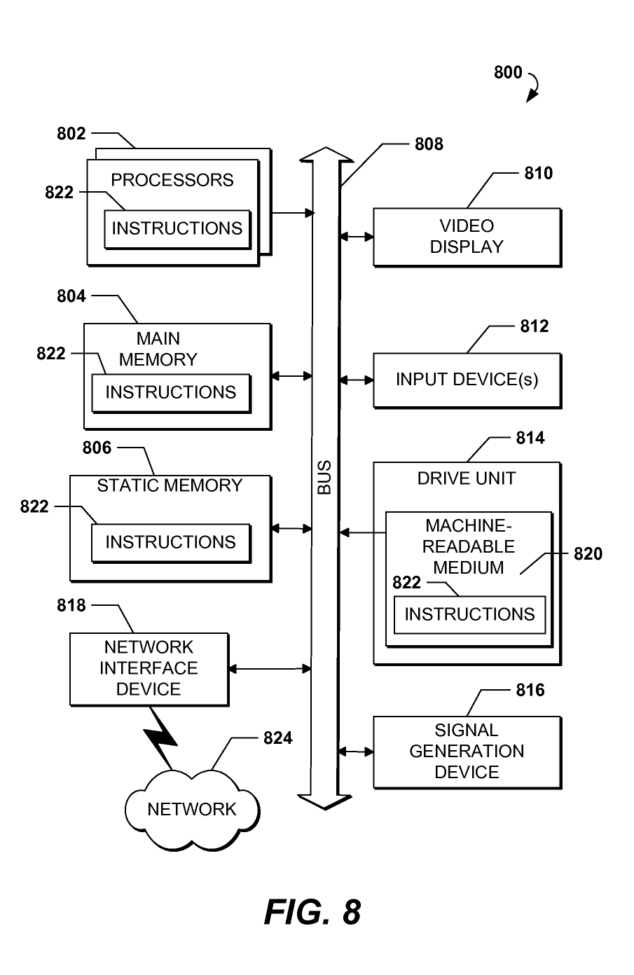

FIG. 8 shows a diagrammatic representation of a computing device for a machine in the example electronic form of a computer system 700, within which a set of instructions for causing the machine to perform any one or more of the methodologies discussed herein can be executed. In example embodiments, the machine operates as a standalone device, or can be connected (e.g., networked) to other machines. In a networked deployment, the machine can operate in the capacity of a server, a client machine in a server-client network environment, or as a peer machine in a peer-to-peer (or distributed) network environment. The machine can be a desktop computer, laptop computer, tablet computer, cellular telephone, portable music player, web appliance, or any machine capable of executing a set of instructions (sequential or otherwise) that specify actions to be taken by that machine. Further, while only a single machine is illustrated, the term “machine” shall also be taken to include any collection of machines that separately or jointly execute a set (or multiple sets) of instructions to perform any one or more of the methodologies discussed herein.

The example computer system 800 includes one or more processors 802 (e.g., a central processing unit (CPU), graphics processing unit (GPU), or both), main memory 804, and static memory 806, which communicate with each other via a bus 808. The computer system 800 can further include a video display unit 810 (e.g., a liquid crystal display). The computer system 800 also includes at least one input device 812, such as an alphanumeric input device (e.g., a keyboard), cursor control device (e.g., a mouse), microphone, digital camera, video camera, and so forth. The computer system 800 also includes a disk drive unit 814, signal generation device 816 (e.g., a speaker), and network interface device 818.

The disk drive unit 814 includes a computer-readable medium 820 that stores one or more sets of instructions and data structures (e.g., instructions 822) embodying or utilized by any one or more of the methodologies or functions described herein. The instructions 822 can also reside, completely or at least partially, within the main memory 804 and/or within the processors 802 during execution by the computer system 800. The main memory 804 and the processors 802 also constitute machine-readable media. The instructions 822 can further be transmitted or received over the network 824 via the network interface device 818 utilizing any one of a number of well-known transfer protocols (e.g., Hyper Text Transfer Protocol (HTTP), CAN, Serial, and Modbus).

While the computer-readable medium 820 is shown in an example embodiment to be a single medium, the term “computer-readable medium” should be understood to include a either a single medium or multiple media (e.g., a centralized or distributed database, and/or associated caches and servers), either of which store the one or more sets of instructions. The term “computer-readable medium” shall also be understood to include any medium that is capable of storing, encoding, or carrying a set of instructions for execution by the machine, and that causes the machine to perform any one or more of the methodologies of the present application. The “computer-readable medium may also be capable of storing, encoding, or carrying data structures utilized by or associated with such a set of instructions. The term “computer-readable medium” shall accordingly be understood to include, but not be limited to, solid-state memories, and optical and magnetic media. Such media may also include, without limitation, hard disks, floppy disks, flash memory cards, digital video disks, random access memory (RAM), read only memory (ROM), and the like.

The example embodiments described herein may be implemented in an operating environment comprising computer-executable instructions (e.g., software) installed on a computer, in hardware, or in a combination of software and hardware. The computer-executable instructions may be written in a computer programming language or may be embodied in firmware logic. If written in a programming language conforming to a recognized standard, such instructions may be executed on a variety of hardware platforms and for interfaces associated with a variety of operating systems. Although not limited thereto, computer software programs for implementing the present method may be written in any number of suitable programming languages such as, for example, C, C++, C#, .NET, Cobol, Eiffel, Haskell, Visual Basic, Java, JavaScript, or Python, as well as with any other compilers, assemblers, interpreters, or other computer languages or platforms.

### CONCLUSION

Thus, methods and systems for dynamic determining a location and orientation data of a display device, such as a head-mounted display, within a 3D environment have been described. The location and orientation data, which is also referred herein to as 6DoF data, can be used to provide 6DoF enhanced virtual reality simulation, whereas user movements and gestures may be translated into corresponding movements and gestures of a user's avatar in a simulated virtual reality world.

Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

1. A method for determining a location and an orientation of a display device utilized by a user, the method comprising:
receiving, by a processor, orientation data from the display device, wherein the orientation data is associated with a user-centered coordinate system, and wherein the display device includes a head-mounted display a head-coupled display or a head wearable computer;
receiving, by the processor, one or more depth maps of a scene, where the user is present;
dynamically determining, by the processor, a location of a user head based at least in part on the one or more depth maps;
generating, by the processor, location data of the display device based at least in part on the location of the user head; and
combining, by the processor, the orientation data and the location data to generate six-degree of freedom (6DoF) data associated with the display device.

2. The method of claim 1, wherein the orientation data includes pitch, yaw, and roll data related to a rotation of the display device within the user-centered coordinate system.

3. The method of claim 1, wherein the location data includes heave, sway, and surge data related to a move of the display device within the user-centered coordinate system.

4. The method of claim 1, wherein the location data includes heave, sway, and surge data related to a move of the display device within a secondary coordinate system, wherein the secondary coordinate system differs from the user-centered coordinate system.

5. The method of claim 1, further comprising processing, by the processor, the one or more depth maps to identify the user, the user head, and to determine that the display device is worn by or attached to the user head.

6. The method of claim 5, wherein the determination of that the display device is worn by or attached to the user head includes:
prompting, by the processor, the user to make a gesture;
generating, by the processor, first motion data by processing the one or more depth maps, wherein the first motion data is associated with the gesture;
acquiring, by the processor, second motion data associated with the gesture from the display device;
comparing, by the processor, the first motion data and second motion data; and
based at least in part on the comparison, determining, by the processor, that the display device is worn by or attached to the user head.

7. The method of claim 6, further comprising:
determining, by the processor, location data of the user head; and
assigning, by the processor, the location data to the display device.

8. The method of claim 1, further comprising:
processing, by the processor, the one or more depth maps to determine an instant orientation of the user head; and
establishing, by the processor, the user-centered coordinate system based at least in part on the orientation of the user head;
wherein the determining of the instant orientation of the user head is based at least in part on determining of a line of vision of the user or based at least in part on coordinates of one or more virtual skeleton joints associated with the user.

9. The method of claim 8, further comprising:
prompting, by the processor, the user to make a predetermined gesture;
processing, by the processor, the one or more depth maps to identify a user motion associated with the predetermined gesture and determine motion data associated with the user motion; and
wherein the determining of the instant orientation of the user head is based at least in part on the motion data.

10. The method of claim 9, wherein the predetermined gesture relates to a user hand motion identifying a line of vision of the user or a user head nod motion.

11. The method of claim 8, further comprising:
prompting, by the processor, the user to make a user input, wherein the user input is associated with the instant orientation of the user head;
receiving, by the processor, the user input;
wherein the determining of the instant orientation of the user head is based at least in part on the user input.

12. The method of claim 8, wherein the establishing of the user-centered coordinate system is performed once and prior to generation of the 6DoF data.

13. The method of claim 1, wherein the 6DoF data is associated with the user-centered coordinate system.

14. The method of claim 1, further comprising processing, by the processor, the one or more depth maps to generate a virtual skeleton of the user, wherein the virtual skeleton includes at least one virtual joint associated with the user head, and wherein the generating of the location data of the display device includes assigning coordinates of the at least one virtual joint associated with the user head to the display device.

15. The method of claim 14, further comprising generating, by the processor, a virtual avatar of the user based at least in part on the 6DoF data and the virtual skeleton.

16. The method of claim 14, further comprising transmitting, by the processor, the virtual skeleton or data associated with the virtual skeleton to the display device.

17. The method of claim 1, further comprising tracking, by the processor, an orientation and a location of display device within the scene, and dynamically generating the 6DoF data based on the tracked location and orientation of the display device.

18. The method of claim 1, further comprising:
identifying, by the processor, coordinates of a floor of the scene based at least in part on the one or more depth maps; and
dynamically determining, by the processor, a distance between the display device and the floor based at least in part on the location data of the display device.

19. The method of claim 1, further comprising sending, by the processor, the 6DoF data to a game console or a computing device.

20. The method of claim 1, further comprising:
receiving, by the processor, 2DoF (two degrees of freedom) location data from an omnidirectional treadmill, wherein the 2DoF location data is associated with swaying and surging movements of the user on the omnidirectional treadmill;
processing, by the processor, the one or more depth maps so as to generate 1DoF (one degree of freedom) location data associated with heaving movements of the user head; and
wherein the generating of the location data includes combining, by the processor, said 2DoF location data and said 1DoF location data.

21. The method of claim 1, further comprising:
processing, by the processor, the one or more depth maps to generate a virtual skeleton of the user, wherein the virtual skeleton includes at least one virtual joint associated with the user head and a plurality of virtual joints associated with user legs;
tracking, by the processor, motions of the plurality of virtual joints associated with user legs to generate 2DoF location data corresponded to swaying and surging movements of the user on an omnidirectional treadmill;
tracking, by the processor, motions of the at least one virtual joint associated with the user head to generate 1DoF location data corresponded to heaving movements of the user head;
wherein the generating of the location data includes combining, by processor, said 2DoF location data and said 1DoF location data.

22. A system for determining a location and an orientation of a display device utilized by a user, the system comprising:
a communication module configured to receive, from the display device, orientation data, wherein the orientation data is associated with a user-centered coordinate system;
a depth sensing device configured to obtain one or more depth maps of a scene within which the user is present; and
a computing unit communicatively coupled to the depth sensing device and the communication unit, the computing unit is configured to:
dynamically determine a location of a user head based at least in part on the one or more depth maps;
generate location data of the display device based at least in part on the location of a user head; and
combine the orientation data and the location data and generate 6DoF data associated with the display device.

23. A non-transitory processor-readable medium having instructions stored thereon, which when executed by one or more processors, cause the one or more processors to implement a method for determining a location and an orientation of a display device utilized by a user, the method comprising:
receiving orientation data from the display device, wherein the orientation data is associated with a user-centered coordinate system;
receiving one or more depth maps of a scene, where the user is present;
dynamically determining a location of a user head based at least in part on the one or more depth maps;
generating location data of the display device based at least in part on the location of the user head; and
combining the orientation data and the location data to generate six-degree of freedom (6DoF) data associated with the display device.
